(19) United States
(12) Patent Application Publication
(10) Pub. No.: US 2005/0002282 A1
(43) Pub. Date: Jan. 6, 2005

(54) Information recording method capable of forming micro marks by optical modulation

(75) Inventor: Tsutomu Shiratori, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/879,081

(22) Filed: Jun. 30, 2004

(30) Foreign Application Priority Data
Jul. 4, 2003 (JP) 2003-191935

(51) Int. Cl. G11B 11/00; G11B 7/00

(52) U.S. Cl. 369/13.25; 369/59.14; 369/13.41

(57) ABSTRACT

A method is provided which forms with high quality record marks smaller than a spot size in overwrite recording according to an optical modulation system. After forming a recording region of a predetermined length by a record pulse Pw1, a rear part of the recording region formed immediately before is erased by an erase pulse Pe after running a scanning distance corresponding to information, thereby forming a plurality of record marks of different lengths in accordance with the information. Furthermore, an interpolation irradiation pulse Pw2 is irradiated for adjusting a medium temperature between the record pulse Pw1 and erase pulse Pe such that a front end of the erasure region formed by the erase pulse Pe is located in a fixed relation with respect to the irradiation position of the second irradiation pulse regardless of the scanning distance.

This application claims priority from Japanese Patent Application No. 2003-191935 filed on Jul. 4, 2003, which is hereby incorporated by reference.

### BACKGROUND OF THE INVENTION

1. Field of the Invention

The present invention relates to a method of recording information on an optical recording medium which records information by overwriting through modulation of the intensity and pulse width of a light beam, that is., optical modulation, and more particularly, to a method of recording information for high-density recording including record marks equal to or smaller than a spot size of the light beam.

2. Related Background Art

As rewritable information recording media, various types of optical recording media are in actual use. In response to a trend of digitization of moving images in recent years, there has been a movement to considerably increase capacities of optical recording media by increasing their recording densities.

Generally, the recording density of an optical disk greatly depends on a laser wavelength of a reproduction optical system and numerical aperture of an objective lens. That is, when a laser wavelength λ of the reproduction optical system and numerical aperture NA of the objective lens are determined, the diameter (spot diameter) of a beam waist is determined, and therefore a spatial frequency at the time of reproduction has a limit of detectability on the order of 2NA/λ. Therefore, a system using a violet laser to shorten the laser wavelength and increasing numerical aperture NA of an objective lens up to approximately 0.85 is starting to become commercialized. However, there are limits to a laser wavelength and numerical aperture of an objective lens. For this reason, aiming at realizing a much higher density, technologies for improving the recording density independently of the spot diameter by improving the structure of a recording medium and the reading method are under development.

As one of these technologies, the present inventors have already proposed in Japanese Patent Application Laid-Open No. H06-290496, a reproduction system using a magneto-optical recording medium called a “domain wall displacement detection (hereinafter referred to as “DWDD”) system” using a domain wall displacement phenomenon due to a temperature gradient and confirmed at a practical level that it is possible to reproduce a high-density recording signal made up of record marks of a size smaller by one order of magnitude than the spot diameter.

However, as for recording, it has been extremely difficult to record a high-density recording pattern finer than to the above described spot diameter using an ordinary optical modulation system as will be described below.

When a domain wall equal to or smaller than the spot diameter is formed with an ordinary optical modulation recording, a so-called pen-point recording using only a portion close to a peak temperature in a temperature distribution induced by irradiation with a light spot on a recording film surface is performed. However, the induced temperature distribution has a Gaussian-like shape having a range corresponding to the spot diameter and the temperature gradient becomes more dull as the temperature approximates to the peak temperature. For this reason, trying to record micro domains, which are smaller than the spot diameter to a certain extent or more, increases fluctuations in the position of the recording temperature boundary, failing to form uniformly shaped domains stably. When, for example, a spot of 1 μm in diameter is used, it has been not possible to form micro domains of approximately 0.3 μm or less stably.

For this reason, a magnetic field modulation system has been used for recording so far. Carrying out magnetic field modulation recording allows high-density recording regardless of the spot diameter, which is a great merit of magneto-optical recording. However, there is also an aspect that carrying out magnetic field modulation recording constitutes a stumbling block in developing the technology as an optical recording medium.

First of all, since the magnetic head needs to be disposed close to the recording film, a structure of substrates bonded to each other cannot be used and this system is disadvantageous in the aspect of mechanical characteristic such as warpage of the substrate especially when developed for a disk having a large diameter. It is also difficult to attain a cartridge-free structure. Furthermore, when recording/reproduction is performed from the film surface side using an objective lens of high NA, it is necessary to arrange the optical head and magnetic head integrally, which makes the structure more complicated. Furthermore, to realize low power consumption, it is essential to increase the sensitivity of the magnetic field of the recording medium and the compatibility between high density and high sensitivity of the magnetic field becomes a fetter to the design of a medium. Moreover, there is also a limit to speed enhancement.

Considering these problems, it is preferable to enable a high-density recording pattern finer than the spot diameter to be recorded according to an optical modulation system without using a magnetic field modulation system. With regard to such a method, the present inventor presented one proposal in Japanese Patent Application Laid-Open No. H06-131722. The proposal is a method of forming a domain, which is large enough to allow stable recording and erasing a rear part of the domain immediately thereafter to form micro domains. As a recording medium for this purpose, by utilizing a structure of an optical modulation overwritable magneto-optical recording medium (hereinafter referred to as “LIMDOW” (Light Intensity Modulation Direct Over-Write) medium) made of an interchangeably coupled multilayered film, it has been made possible to perform recording and erasing operations instantaneously and successively without switching the direction of the magnetic field. Hereinafter, this system is called a “domain rear part erasing system”.

However, at the time of the presentation of this proposal, it was impossible to read micro domains such as a pattern of record marks which are smaller by one order of magnitude than the spot diameter for reasons related to reproduction resolution. For this reason, the effect of the method could be confirmed only at a level of improvement of a signal amplitude and recording power margin within the reproducible range. Later, a method of reproducing high-density recording signals exceeding the resolution of optical spots such as the above-described DWDD was invented, but recording was performed by magnetic field modulation recording and no investigation has been made into the domain rear part erasing system so far. This is because it has been impossible to study technologies unestablished on both the reproduction side and recording side simultaneously.

Since the DWDD technology on the reproduction side was established this time, a recording medium of a structure combining the DWDD layer structure and LIMDOW layer structure was created and the domain rear part erasing system was studied. The result has elucidated the problem that trying to actually record a random pattern made up of record marks which are smaller by one order of magnitude than the spot diameter using the domain rear part erasing system resulted in a failure to record marks of an arbitrary length-using a simple recording compensation method or resulted in large pattern dependency remaining in the mark length recorded due to a great influence of thermal interference.

That is, according to the recording compensation method used in conventional optical modulation recording, in order to form record marks of different lengths, record marks of predetermined lengths were formed by changing the laser irradiation intensity, the irradiation time, the number of times of irradiations, or the like. However, when different temperature states are induced on the medium through such operations, the temperature distribution formed on the medium will change according to the length of the immediately preceding record mark in the immediately succeeding erasing operation, and to compensate for this, there is a necessity to realize quite complicated recording compensation which cannot be realized by an ordinary recording system such as changing the erasing conditions for every mark length.

### SUMMARY OF THE INVENTION

The present invention has been accomplished in view of the above-described problems and it is an object of the present invention to provide an information recording method capable of stably recording by overwriting a high-density recording pattern finer than the spot diameter according to an optical modulation system.

The information recording method of the present invention is a method of recording information on an optical recording medium by overwrite recording record marks while making switching between a first irradiation pulse for forming a recording state and a second irradiation pulse for forming an erasure state according to information, comprising the steps of forming a recording region of a predetermined length by means of the first-irradiation pulse, and then erasing a rear part of the formed recording region by means of the second irradiation pulse after running a scanning distance corresponding to information, thereby forming a plurality of record marks of different lengths in accordance with the information.

### BRIEF DESCRIPTION OF THE DRAWINGS

FIG. 1 is a view (part (a)) illustrating an example of drive waveform of a recording laser and a schematic view (part (b)) of a domain formed on a memory layer through the driving of the recording laser shown in part (a);

FIG. 2 is a view illustrating temperature distributions induced on a recording medium surface in respective processes when the recording laser is driven as shown in part (a) of FIG. 1;

FIG. 3 is a view illustrating a laser drive waveform of an 8T continuous pattern at a write strategy of the present invention applied in Example 1;

FIG. 4 is a view illustrating a laser drive waveform of an 8T continuous pattern at a write strategy of the present invention applied in Example 2;

FIG. 5 is a view illustrating recording power dependency of jitter when recording is performed according to the write strategy of Example 2;

FIG. 6 is a view illustrating a laser drive waveform of an 8T continuous pattern at a write strategy applied to Comparative Example;

FIG. 7 is a view illustrating laser drive waveforms of erase pulses and record pulses corresponding to 2T to 8T in the write strategy applied in Example 1;

FIG. 8 is a view illustrating laser drive waveforms of erase pulses and record pulses corresponding to 2T to 8T in the write strategy applied in Example 2; and

FIG. 9 is a view illustrating laser drive waveforms of erase pulses and record pulses corresponding to 2T to 8T in a write strategy applied in Example 3.

### DESCRIPTION OF THE PREFERRED EMBODIMENTS

The present invention is illustrated in greater detail below with reference to the following Examples, but the invention should not be construed as being limited thereto.

The following Examples show those cases in which the recording method of the present invention is applied to the above described domain rear part erasing system, but the method of the present invention is not limited to these examples and can arbitrarily form physical states that differ corresponding to modulation of light beam such as a phase variation type optical recording medium and can be applied to any recording medium as long as it is an optical recording medium capable of at least overwriting a once formed physical state with another physical state immediately thereafter.

Here, for ease of an understanding of examples, the basic operation of LIMDOW and domain rear part erasing system will be explained briefly. The basic structure of a LIMDOW medium consists of a memory layer (M layer)/write layer (W layer)/switching layer (S layer)/initializing layer (I layer) designed so that the Curie temperature increases in order of the S layer<M layer<W layer<I layer (see Japanese Patent Application Laid-Open No. H01-241051 for details). Through modulation of recording laser light, the medium temperature of the laser irradiation region is modulated between two types of temperature levels; a level equal to or higher than Curie temperature Tw of the W layer and equal to or lower than Curie temperature Ti of the I layer and a level equal to or higher than Curie temperature Tm of the M layer and equal to or lower than Tw, and an overwrite is carried out by orienting magnetization of the memory layer according to various temperature levels as will be described below.

Suppose the spin orientation state formed in the memory layer when heated to Tw is a recording state and the state formed when heated to Tm is an erasure state in the following explanations. The I layer is initialized/magnetized to a full erasure state, has the highest Curie temperature and always keeps the erasure state without any magnetization inversion through the operation of heating to the above described temperature level.

First, when heated to Tw, the W layer is oriented to a recording state by an action of an external magnetic field applied in a predetermined direction. When the medium temperature is reduced to Tm or below in a subsequent cooling step, the M layer is also oriented to a recording state by an exchange interaction with the W layer. When the medium temperature is further reduced to the Curie temperature Ts of the S layer, the W layer is exchange coupled with the I layer via the S layer and the W layer is re-inverted and initialized to an erasure state by that action. At this time, the M layer is supported by a drastic increase of coercive energy accompanying a reduction of the medium temperature and keeps the recording state against the exchange interaction with the W layer.

On the other hand, when heated to Tm, since the coercive force energy is still sufficiently large at this temperature, the W layer keeps the initialized erasure state and the coercive force energy of the M layer falls drastically in the process of being heated to the Curie temperature, and therefore the M layer is oriented to an erasure state through exchange interaction with the W layer. In this way, it is possible to magnetize and orient the memory layer in accordance with two types of temperature levels and record new information through only modulation of recording light regardless of the magnetized state before recording. This is the basic operation of LIMDOW.

Using this LIMDOW medium, a series of operations of forming stably recordable and sufficiently large domains in the memory layer, erasing a rear part of this domain immediately thereafter and forming micro domains will be explained using a typical example shown in FIG. 1.

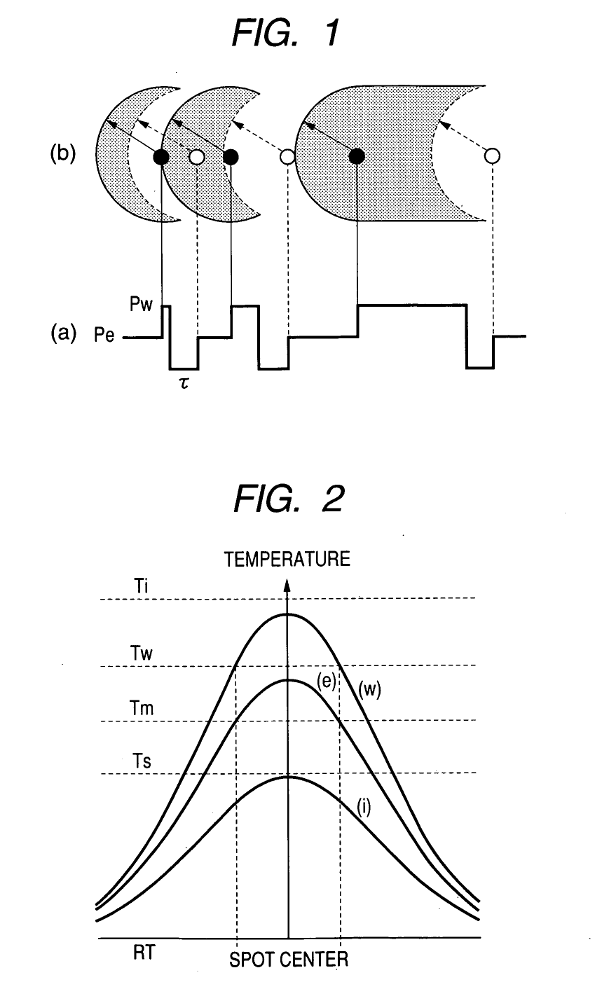

FIG. 1 illustrates in (a) thereof an example of a recording laser drive waveform and FIG. 1 also schematically shows in part (b) a domain formed thereby on the memory layer. Furthermore, a temperature distribution on the recording film surface formed when laser power Pw and Pe described in part (a) of FIG. 1 are irradiated is shown by the temperature distribution (w) and temperature distribution (e) described in FIG. 2. Furthermore, the temperature distribution immediately before the laser power Pe is irradiated is shown by the temperature distribution (i) shown in FIG. 2. Hereafter, when a laser is driven as shown in part (a) of FIG. 1, the process of a phenomenon that occurs in the recording film after the pulse of the start power level Pw in the figure is irradiated, through a laser stop period τ until a laser of power level Pe is irradiated will be explained.

When the laser with Pw is irradiated, a temperature distribution (w) in which the region corresponding to the spot size on the recording film surface becomes Tw or more is induced and when laser irradiation is stopped, cooling with heat dissipation starts. In this cooling process, the W layer in the region heated to Tw or more is oriented to a recording state and then its domain is transferred to the M layer. When cooling further advances, initialization of the domain of the W layer starts from a peripheral portion thereof and when a temperature distribution (i) whose peak temperature is Ts or below is attained, the W layer is completely initialized. The process up to this point is completed immediately before the laser with power level Pe is irradiated next time. At this point of time, the circular domain shown at the head of part (b) of FIG. 1 is formed in the memory layer. Then, when the laser of power level Pe is irradiated, a temperature distribution (e) in which the region corresponding to the spot size becomes Tm or more is induced and the domain in the region is erased. Depending on the distance by which the medium has moved after the laser with power level Pw is irradiated until the laser with power level Pe is irradiated next, the erasure region is shifted to the rear side of the domain recorded immediately before, and therefore the second circular portion indicated by dotted lines in part (b) of FIG. 1 is erased and a crescent micro domain remains at the front part.

The length of the finally formed domain and the length of the erasure region can be arbitrarily determined depending on the irradiation periods of Pw and Pe as shown in FIG. 1. In this way, it is possible to record a high-density recording pattern including record marks finer than the spot diameter according to an optical modulation system (the above-described technology is already disclosed in Japanese Patent Application Laid-Open No. H06-131722).

Then, the optical recording medium used in this example will be explained. As described above, in this example, high-density was carried out by the domain rear part erasing system using a magneto-optical recording medium having a combined structure of the DWDD layer structure and LIMDOW layer structure. The layer structure of the magnetic layer of this magneto-optical recording medium is shown in Table 1. The part of D1/D2/C/Sr/M constitutes the layer structure for realizing reproduction by DWDD and the part of M/Int/W/Sw/I constitutes the layer structure for realizing recording by LIMDOW.

Since a switching layer which performs the function of making switching ON/OFF of exchange coupling between layers exists in each of the structures of DWDD and LIMDOW, the former of the two switching layers is designated as an Sr layer and the latter is designated as an Sw layer for distinction. The domain wall displacement layer is constituted of two layers with different Curie temperatures and saturation magnetization is canceled within a reproduction temperature range so as to suppress influences of a floating magnetic field on the domain wall displacement operation. Furthermore, between the M layer and W layer, a magnetic layer for adjusting the intensity of exchange interaction between the both layers is inserted as an intermediate layer (Int layer).

In the design of the Curie temperature of the respective magnetic layers, what should be particularly noted in realizing the process of the domain rear part erasing system is the design of Curie temperatures of the magnetic layers involved in respective temperatures of recording, erasure and initialization, that is, W layer, M layer and Sw layer. After being heated to the recording temperature, the magnetic layers are instantaneously cooled down to the initialization temperature, initialized and heated up to the erasure temperature immediately thereafter, and therefore the smaller the difference among the respective temperatures, the better. In the case of an ordinary LIMDOW medium, when a temperature distribution of the erasure temperature level is formed, the peak temperature of the distribution should not exceed the recording temperature, and therefore it is necessary to provide a large difference between the recording temperature and erasure temperature. However, in the case of the domain rear part erasing system, even if domains are written in the high temperature portion at the center when an erasure operation is carried out, that portion can be overwritten through the subsequent recording or erasure operation, and therefore there is no problem. For this reason, it is possible to design the Curie temperature in the M layer to a high temperature near the Curie temperature of the W layer. In this example, the difference between the two is designed to be 50° C. or less. Consequently, the Curie temperature of the Sw layer can also be designed to a high temperature close to the Curie temperature of the M layer within the range in which the initialization of the W layer causes no influences on the magnetization state of the M layer. In this example, the difference between the Curie temperature of the W layer and that of the Sw layer is suppressed to 100° C. or less.

Furthermore, the design of the thermal structure for efficient cooling is also important. The medium used for this example is made up of an SiN base layer and a protective layer formed in thicknesses of 35 nm and 20 nm respectively on both sides of the magnetic layer and a heat dissipation layer of an Al alloy of 100 nm in thickness is further provided through the protective layer.

For stabilization of the domain wall displacement operation, after an upper layer is formed, it is removed from the film formation apparatus and both sides of recording tracks are annealed using a high output laser. Furthermore, after the film formation, a magnetic field on the order of 15 kOe is applied using a permanent magnet to initialize the entire surface of the I layer. When the productivity is taken into consideration, initialization can also be performed simultaneously with annealing. Alternatively, it is also possible to optimize the surface shape of the substrate and film formation conditions to omit the annealing.

### EXAMPLE 1

On the above-described magneto-optical recording medium, a fine pattern of a high density higher than the resolution of the optical system was, recorded according to a domain rear part erasing system, this pattern was DWDD-reproduced and the recording characteristic was evaluated. For the evaluation, an optical system with a laser wavelength of 660 nm and an objective lens of NA 0.60 was used. The spot diameter is approximately 0.92 μm. The linear speed for recording/reproduction was set to 3.0 m/sec.

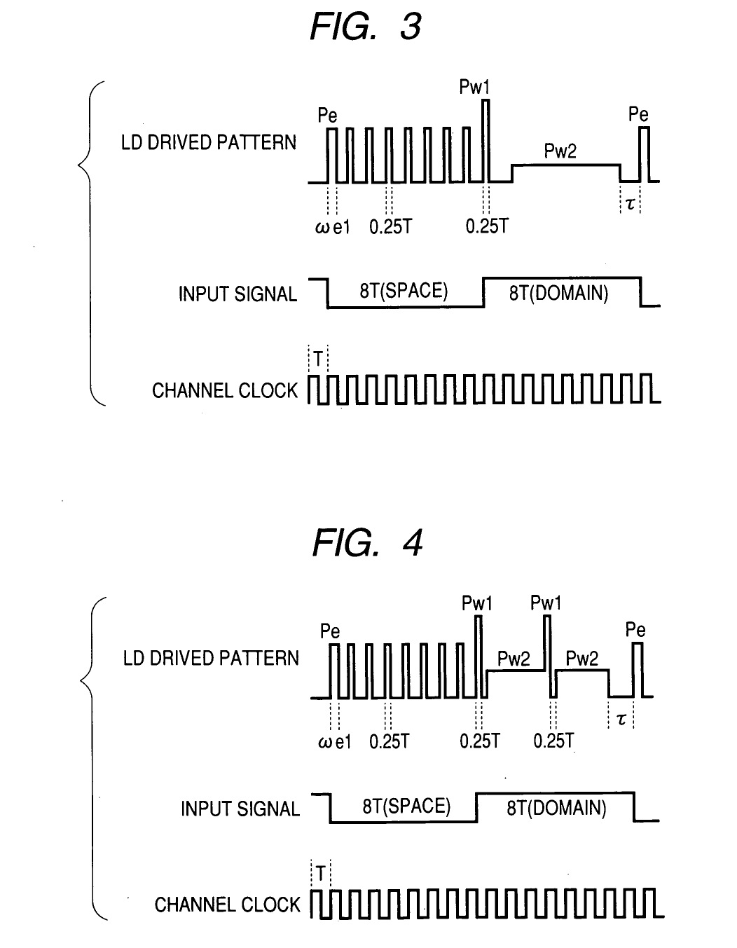

FIG. 3 illustrates a laser drive waveform of an 8T continuous pattern (T: channel clock) at a write strategy of the present invention applied when mark-edge recording a random pattern of a shortest mark length of 0.1 μn through (1, 7) RLL modulation.

The power level is modulated with four values; two values for recording, one value for erasure and bottom fixed to 0 mW. A recording state which is a physical state corresponding to information “1” is formed with a pulse of power level Pw1 and an erasure state which is a physical state corresponding to information “0” is formed with an erase pulse of power level Pe. The role of the power level Pw2 that is a characteristic feature of the present invention will be described later.

As an erase pulse (second irradiation pulse), one pulse per 1 T is provided and the pulse width of the start pulse is made variable. All pulse widths of the second pulse onward are fixed to 0.25 T. The power level Pe of erase pulses was set to a power level capable of heating to an erasure temperature or higher when continuous pulses of 0.25 T are irradiated. The pulse width ωe1 of the start pulse is adjusted such that the temperature state immediately before irradiation of the subsequent record pulse (first irradiation pulse) always becomes constant when the space length (length of the physical state corresponding to information “0”) is changed from 2 T to 8 T.

Then, the record pulse will be explained. The (1, 7) RLL modulation requires marks of 7 types of lengths-from 2 T to 8 T to be formed, but since the shortest mark length 2 T is 0.1 μm, the longest 8 T needs only to form a mark of 0.4 μm at most. Therefore, a domain (region in the recording state) of approximately 0.45 μm in length is firstly formed with a record pulse of power level Pw1 (first irradiation pulse) at the head. Immediately thereafter, a rear part of this domain is erased by an erase pulse after running a scanning distance of light beam corresponding to the length of the domain to be formed (length of the physical state corresponding to information “1”). The irradiation timing of the subsequent start pulse for erasure is shifted in seven stages by 1 T at a time depending on the length of the domain to be formed, and in order to ensure that the temperature state immediately before irradiating this erase pulse is always constant irrespective of the amount of shift, an interpolation irradiation pulse of power level Pw2 is irradiated after irradiation of the record pulse for a period corresponding to the amount of shift. It is preferable to determine a specific value of this power level Pw2 and pulse value, etc., from experiments because they vary depending on the temperature sensitivity of the medium and linear speed, etc. More specifically, it is possible to record record marks of respective mark lengths while varying the power level of Pw2 and irradiation time and determine an optimum Pw2 based on the error rate, jitter, time interval, etc., of the reproduction signals of those record marks. Here, after providing a 1 T cooling gap before and after the interpolation irradiation pulse, the optimum Pw2 was determined.

Furthermore, the amount of delay corresponding to the clock of the erase pulse is adjusted, the domain length and the space length for every T are matched to remove asymmetry.

In the domain finally formed by the domain rear part erasing system, the domain wall position on the front part is determined with a temperature distribution by irradiation of the start record pulse and the domain wall position on the rear part is determined with a temperature distribution by irradiation of the start erase pulse. Since the temperature state immediately before irradiating each of the pulses is always kept constant by the above described write strategy regardless of the recording pattern, the preceding and succeeding domain wall positions are determined at positions precisely shifted in increments of 1 T according to timings in 1 T increments of the respective pulse irradiations, making it possible to suppress pattern dependency at the time of random signal recording.

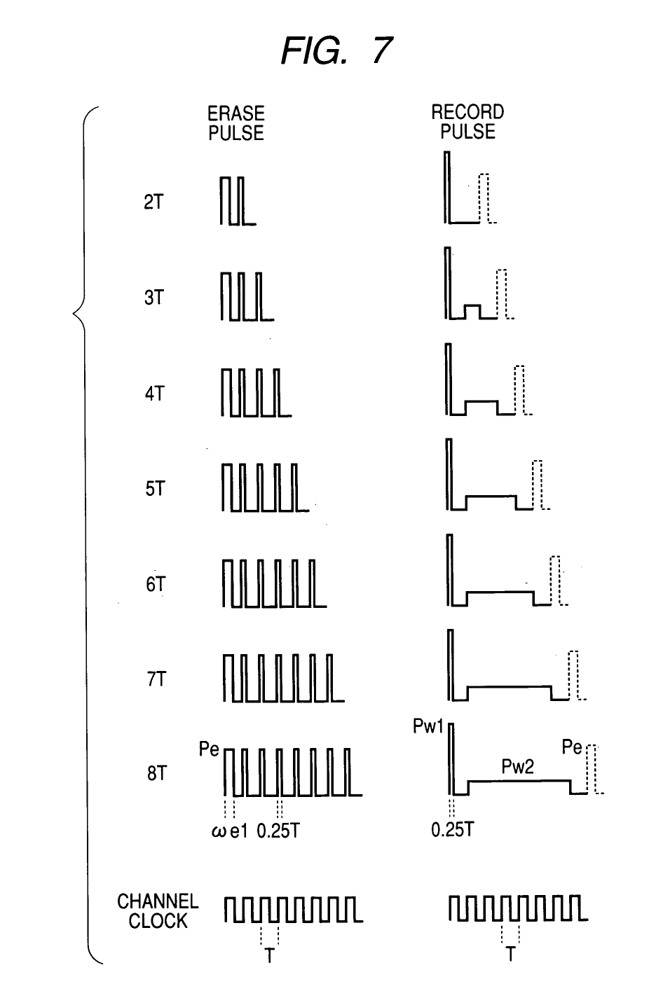

FIG. 7 illustrates laser drive waveforms of an erase pulse and record pulse corresponding to 2 T to 8 T in the write strategy applied in this example.

Recording according to this write strategy provided a good eye pattern and provided summation jitter equivalent to jitter when a tone signal was recorded. It can be said that the pattern dependency due to influences of thermal interference during random signal recording is completely suppressed.

### EXAMPLE 2

FIG. 4 illustrates a laser drive waveform of an 8 T continuous pattern at a write strategy of the present invention applied when mark-edge recording a random pattern having the shortest mark length of 0.15 μm on the same recording medium as that in Example 1 with (1, 7) RLL modulation.

In this case, since the shortest mark length 2 T is 0.15 μm, the longest 8 T requires a 0.6 μm mark. Therefore, if a domain of 0.6 μm or more in length is formed with a record pulse with start power level Pw1, it is possible to record with completely the same write strategy as that in Example 1. However, when too a large domain is formed with one pulse, the central temperature in the temperature distribution during recording becomes high, so that magnetization inversion of the I layer is likely to occur, failing to secure a sufficient recording power margin or the time required for initialization cooling may become long to make it unable to perform high-speed recording.

Therefore, in this example, a domain of approximately 0.45 μm was formed with one pulse, domain lengths of 2 T to 5 T were formed by erasing a rear part of this domain, domain lengths of 6 T to 8 T were formed by irradiating a pulse of power level Pw1 at 5 T again to add a domain and erasing a rear part of this domain. After irradiation of the record pulse, as with Example 1, an interpolation irradiation pulse of power level Pw2 was irradiated. However, in this example, in order to prevent the domain formed by the start record pulse from being erased with the second record pulse, the cooling gap after irradiation of the record pulse was shortened to 0.25 T, a balance was achieved among the respective parameters so that the temperature of the start pulse irradiation section could be kept at the initialization temperature or more until irradiation of the second pulse with power level Pw2.

Incidentally, in this example, the start record pulse and second record pulse were set to have the same pulse width with the same power, but it is also possible to set the second record pulse independently of the start pulse to different power or pulse width.

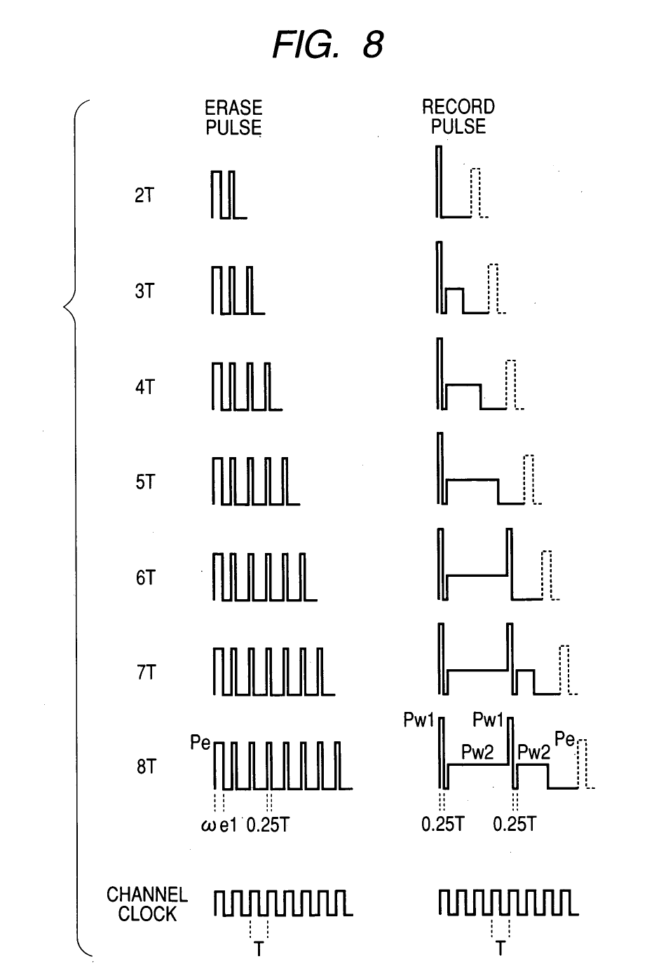

FIG. 8 illustrates laser drive waveforms of an erase pulse and record pulse corresponding to 2 T to 8 T in the write strategy applied in this example.

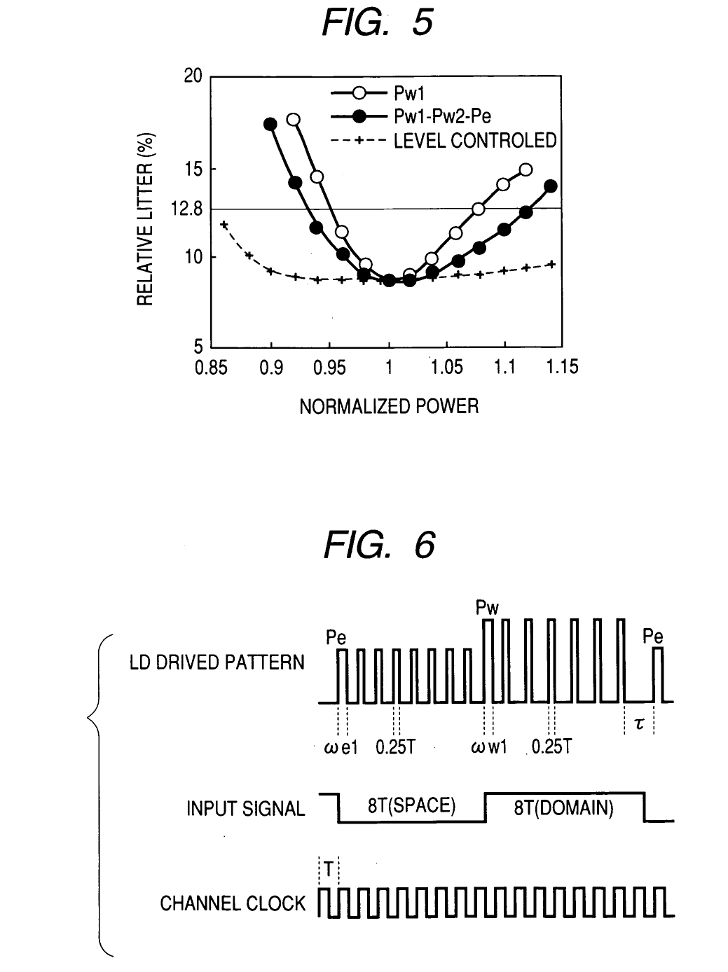

FIG. 5 illustrates recording power dependency of jitter when recording is performed according to the above described write strategy. The relative jitter on the ordinate is obtained by measuring summation jitter which incorporates both rise to fall and fall to rise, converting it to data to clock jitter and calculating a ratio with respect to the window width. The normalized power on the abscissa is obtained by normalizing the respective powers by optimum recording powers of Pw1=28.0 mW, Pw2=6.8 mW and Pe=23.0 mW. In the figure o indicates power dependency when Pw2 and Pe are fixed and only Pw1 is varied and * indicates power dependency when Pw1, Pw2 and Pe are changed simultaneously. Assuming a relative jitter of 12.8% corresponding to a bit error rate of 1×10⁻⁴ as a criterion, the power margin becomes approximately ±6.5% for the former and approximately ±9.5% for the latter. The latter can be considered a power margin appropriate for the actual situation of use. IN the domain rear part erasing system, when Pe fluctuates in accordance with Pw1 variations, the domain length is automatically compensated, and therefore the power margin is considered to increase compared to the case where only Pw1 fluctuates.

The above-described jitter is measured by applying fixed slicing at the center of the amplitude, but when the slice level is adjusted according to asymmetry, much wider power margins of ±15% or more were obtained as indicated by dotted lines.

### EXAMPLE 3

In the write strategy shown in Example 1, considering the erasure side in completely the same way as the recording side, a space (region in the erasure state) of approximately 0.45 μm in length is formed with only the start erase pulse and then space lengths of all patterns are recorded according to the irradiation timing of subsequent record pulses.

In this case, the irradiation timings of start pulses for subsequent recordings are shifted in seven stages by 1 T at a time according to the space length to be formed, but an interpolation irradiation pulse of power level Pe2 is irradiated after irradiation of the start erase pulse for a period according to the amount of shift such that the temperature state immediately before this record pulse is irradiated is always fixed irrespective of the amount of shift.

Furthermore, in this example, after irradiation of the start record pulse, the interpolation irradiation pulse on the recording side is designed so as to be irradiated while successively descending the level from Pw1 to Pw2 without providing any cooling gap.

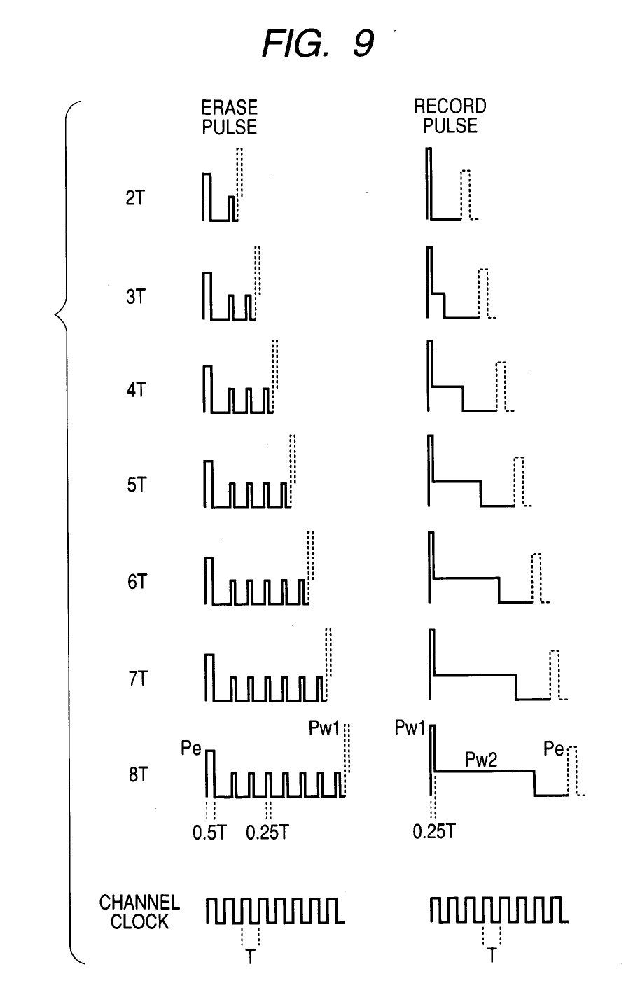

FIG. 9 illustrates laser drive waveforms of an erase pulse and record pulse corresponding to 2 T to 8 T in the write strategy applied in this example.

The temperature for forming an erasure state is lower than the temperature for forming a recording state, and therefore even when the above-mentioned system is applied to the erasure side, not so large effects as those on the recording side are obtained, but when higher-density recording is performed, the effects are estimated to become more prominent.

### COMPARATIVE EXAMPLE

Based on the concept of the conventional recording compensation method, a laser was driven and recording was performed such that the recording temperature region was widened by 1 T every time the length was extended by 1 T corresponding to the mark length.

In this comparative example, when a random pattern of the shortest mark length of 0.15 μm was mark-edge recorded with (1, 7) RLL modulation as in the case of Example 2, a write strategy was applied with a laser drive waveform of an 8 T continuous pattern such as shown in IG. 6. Erase pulses and record pulses were provided at intervals of 1 T according to the mark length. In order to secure the cooling gap for initialization cooling between an erase pulse and a record pulse, (n−1) record pulses were used for a mark length of nT. Since the temperature states immediately before light emission of the start erase pulse and start record pulse are lower than those of the subsequent pulses, adjustments are made so as to widen the pulse width and induce a temperature distribution equivalent to that of the subsequent pulses.

An attempt was made to record a random pattern using this recording method, but it was not possible to find out recording conditions capable of forming both short marks of up to approximately 0.3 μm and marks longer than 0.3 μm to an appropriate length no matter how each parameter was adjusted, failing to obtain a good recording characteristic.

The fundamental difference between the recording method of such a comparative example and the recording method of the present invention is that the recording method of the comparative example sets power for inducing a temperature distribution capable of forming a recording state for every record pulse. On the contrary, the recording method of the present invention basically has only one first record pulse (first irradiation pulse) for inducing a temperature distribution capable of forming a recording state and other record pulses are functioning as interpolation pulses for adjusting temperatures so that the temperature state on the medium immediately before irradiating an erase pulse (second irradiation pulse) becomes constant. Then, when the mark to be formed becomes longer than the recording region formed by one record pulse, a record pulse for inducing a temperature distribution capable of forming a recording state is irradiated again.

According to the recording method of the comparative example, since incoming thermal energy changes a great deal every time the length of the mark to be recorded changes, a compensation operation for making uniform the immediately following temperature state becomes extremely complicated and difficult, while in the recording method of the present invention, the recording operation is the same even if the length of the mark to be recorded changes within a certain range, and therefore the incoming thermal energy is invariable and it is only necessary to compensate for a change of the heat dissipation state at timings for carrying out subsequent erasure operations with interpolation pulses.

The above described examples have only shown examples recorded with (1,. 7) RLL modulation codes, but the present invention does not limit modulation codes and is also applicable to modulation codes with no restrictions on the longest mark length.

TABLE 1

| Layer | | Material | Tc | Thickness |
|---|---|---|---|---|
| D1 | (Displacement Layer) | GdFeCoCr | 290° C. | 18 nm |
| D2 | | GdFeCr | 210° C. | 18 nm |
| C | (Control Layer) | TbFeCoCr | 180° C. | 18 nm |
| Sr | (Switching Layer) | TbFeCr | 160° C. | 10 nm |
| M | (Memory Layer) | TbFeCoCr | 280° C. | 60 nm |
| Int | (Intermediate layer) | GdFeCoCr | 310° C. | 30 nm |
| w | (Writing Layer) | TbFeCoCr | 320° C. | 20 nm |
| Sw | (Switching Layer) | TbFeCoCr | 230° C. | 10 nm |
| I | (Initializing Layer) | TbFeCoCr | >380° C. | 30 nm |

Table 1 shows a layer structure of magnetic layers of a magneto-optical recording medium used in the Examples.

From the foregoing, it will be obvious to those skilled in the art that various modifications in the above-described methods can be made without departing from the spirit and scope of the invention. Accordingly, the invention may be embodied in other specific forms without departing from the spirit or essential characteristics thereof.

1. A method of recording information on an optical recording medium by overwrite recording record marks while making switching between a first irradiation pulse for forming a recording state and a second irradiation pulse for forming an erasure state according to information, comprising the steps of forming a recording region of a predetermined length by means of the first irradiation pulse, and then erasing a rear part of the formed recording region by means of the second irradiation pulse after running a scanning distance corresponding to information, thereby forming a plurality of record marks of different lengths in accordance with the information.

2. The method according to claim 1, further comprising the step of irradiating interpolation irradiation pulses for adjusting a medium temperature between the first irradiation pulse and the second irradiation pulse such that a front end of the erasure region formed by means of the second irradiation pulse is located in a fixed relation with respect to the irradiation position of the second irradiation pulse regardless of the scanning distance.

3. The method according to claim 1, wherein the first irradiation pulse is a single irradiation pulse.

4. The method according to claim 1, wherein the first irradiation pulse consists of a plurality of irradiation pulses.

5. The method according to claim 2, wherein the interpolation irradiation pulse is irradiated such that the temperature state on the medium immediately before irradiation with the second irradiation pulse is always constant.

6. The method according to claim 1, wherein the optical recording medium is a phase change medium.

7. The method according to claim 1, wherein the optical recording medium is a magneto-optical medium comprising a first magnetic layer part for realizing reproduction by domain wall displacement including a displacement layer, a control layer, a switching layer and a memory layer, and a second magnetic layer part for realizing optical modulation overwriting including a memory layer, an intermediate layer, a writing layer, a switching layer and an initializing layer, and the memory layer is commonly owned by the two magnetic layer parts.
